(19) United States
(12) Patent Application Publication
(10) Pub. No.: US 2025/0089107 A1
(43) Pub. Date: Mar. 13, 2025

(54) Communication Method For Off-Road Vehicle Group And Portable Communication Device

(71) Applicant: Zhejiang CFMOTO Power Co., Ltd., Hangzhou, Zhejiang (CN)

(72) Inventor: Yujie Wang, Hangzhou (CN)

(21) Appl. No.: 18/957,801

(22) Filed: Nov. 24, 2024

Related U.S. Application Data
(63) Continuation of application No. PCT/CN2023/097031, filed on May 30, 2023.

(30) Foreign Application Priority Data
Nov. 30, 2023 (CN) 202311630903.3

(51) Int. Cl. H04W 76/10; G07C 5/00; H04W 4/40; H04W 88/06

(52) U.S. Cl. CPC H04W 76/10; H04W 4/40; G07C 5/008; H04W 88/06

(57) ABSTRACT

A communication method for an off-road vehicle group is applied to a first portable communication device. The first portable communication device includes a short-range communication module and a long-range communication module, both sending and receiving unlicensed transmissions, as well as a positioning module such as a GPS chip. The method includes: establishing a communication between the first portable communication device and a first off-road vehicle based on the short-range communication module, and obtaining driving information of the first off-road vehicle; establishing a communication between the first portable communication device and a second portable communication device based on the long-range communication module, and the second portable communication device establishing a communication with a second off-road vehicle; and sending driving information of the first off-road vehicle and location information of the first portable communication device to the second portable communication device based on the long-range communication module.

### RELATED APPLICATION INFORMATION

The present disclosure claims priority to the Chinese Patent Disclosure No. 202311630903.3, filed on Nov. 30, 2023. The entire contents of the above-referenced disclosure is incorporated herein by reference.

### FIELD OF THE DISCLOSURE

The present application relates to the field of vehicle communications, and in particular to a communication method for an off-road vehicle group and a corresponding portable communication device.

### BACKGROUND OF THE DISCLOSURE

With rapid development of a communication technology for vehicles, vehicles have increasingly powerful communication and interaction capabilities, which can further meet needs of users. In related technologies, a vehicle can establish a connection with another vehicle based on a cellular service, so as to complete a grouping of vehicles, and realize data sharing and communication between the vehicles.

However, some off-road vehicles, such as all-terrain vehicles, off-road motorcycles, snowplows, snowmobiles, golf carts, etc., travel in areas including deserts, jungles, beaches, wastelands and other outdoor areas. In many of these areas, there are situations where the cellular service cannot be accessed or signal connection to the cellular service is limited, such as when outside network coverage areas or during a network outage of the cellular service. In areas with poor signal coverage, a vehicle cannot establish the connection with another vehicle based on the cellular network, and is prone to disconnection if a connection is made, which results in a poor stability of vehicle networking. Often the poor stability of vehicle networking occurs at the precise moment (for instance, in days after a hurricane) that vehicle networking is needed most.

### SUMMARY OF THE INVENTION

The present invention is a communication method for an off-road vehicle group and a corresponding portable communication device, which solves the prior art technical problems of easily dropped communication between vehicles is and poor stability of vehicle networking.

In a first aspect, the present application provides a communication method for an off-road vehicle group which includes a first off-road vehicle and a second off-road vehicle. Each of the two off-road vehicles is provided with a portable communication device. The portable communication devices each include a short-range communication module, a long-range communication module, and a positioning module. The short-range communication module of the first portable communication device is capable of establishing unlicensed communication with the first off-road vehicle and acquiring driving information of the first off-road vehicle. The short-range communication module of the second portable communication device is capable of establishing unlicensed communication with the second off-road vehicle and acquiring driving information of the second off-road vehicle. Driving information of the first off-road vehicle and positioning information of the first portable communication device is transmitted from the long-range communication module of the first portable communication device to the long-range communication module of the second portable communication device via an unlicensed communication over a communication distance greater than a range of the first and second short-range communication modules.

In another aspect, the first portably communication device is capable of acquiring driving information of the first off-road vehicle only when the first portable communication device is determined to be within the first off-road vehicle. By limiting communication between the first portable communication device and the first off-road vehicle to times when the first portable communication device is separately sensed/determined to be within the first off-road vehicle, unauthorized portable communication devices are prevented from maliciously establishing communication with the off-road vehicle, ensuring communication security.

Since both the short-range communications and the long-range communications are through an unlicensed communications channel, the methods and devices of the present invention are not dependent on a cellphone network or similar network to communicate both vehicle information and location information. Further, since the methods and devices rely on the positioning modules of the portable communication devices, no positioning module is required in the off-road vehicles themselves.

### BRIEF DESCRIPTION OF THE DRAWINGS

FIG. 1 is a schematic diagram of an application scenario of a communication method in accordance with a preferred embodiment of the present invention.

FIG. 2 is a schematic diagram of communication modules in the off-road vehicles and portable communication devices of FIG. 1.

FIG. 3 is a flow chart of a communication method provided in a preferred embodiment of the present invention.

FIG. 4 is a schematic diagram showing further components of the first off-road vehicle and first portable communication device of FIGS. 1 and 2.

FIG. 5 is a schematic diagram of communication modules of a communication method involving a third off-road vehicle and a third portable communication device.

FIG. 6 is a schematic diagram of an application scenario of a communication method in accordance with a preferred embodiment of the present invention involving three off-road vehicles, three portable communication devices and three mobile computing devices.

FIG. 7 is a schematic diagram showing the communication modules of the embodiment of FIG. 6.

### DETAILED DESCRIPTION

To facilitate understanding, some illustrations of concepts related to embodiments of the present application are given by way of examples for reference.

It should be noted that in this application, “at least one” means one or more, and “more” means two or more than two. “And/or” describes an association relationship of associated objects, indicating that three relationships may exist. For example, A and/or B can mean: A exists alone, A and B exist at the same time, and B exists alone, where A and B can be singular or plural. The terms “first”, “second”, “third”, etc. in the specification, claims and drawings of this application are used to distinguish similar objects, rather than to describe a specific order or a sequence.

In order to solve the technical problem that a connection between vehicles is easily disconnected and an efficiency of grouping for vehicles is low, the present invention provides a communication method, and sets of electronic devices and vehicles in accordance with the communication method. The method realizes a communication with a first off-road vehicle by a short-range communication module of a first portable communication device, and realizes a communication with a second portable communication device based on the long-range communication modules of the first and second portable communication devices, where the second portable communication device establishes a short-range communication with the second off-road vehicle. The communications all occur at relatively low power and unlicensed transmissions, and are not subject to cellphone or licensed network coverage areas and outages. Even if the vehicles are in an area with poor cellphone network coverage, the communications of the present invention can still be achieved, thereby ensuring a stability of the grouping of vehicles. Driving and location information is sent via long-range communication modules of the first and second portable communication devices, thereby achieving a purpose of sharing the driving information of the first off-road vehicle with a user of the second off-road vehicle.

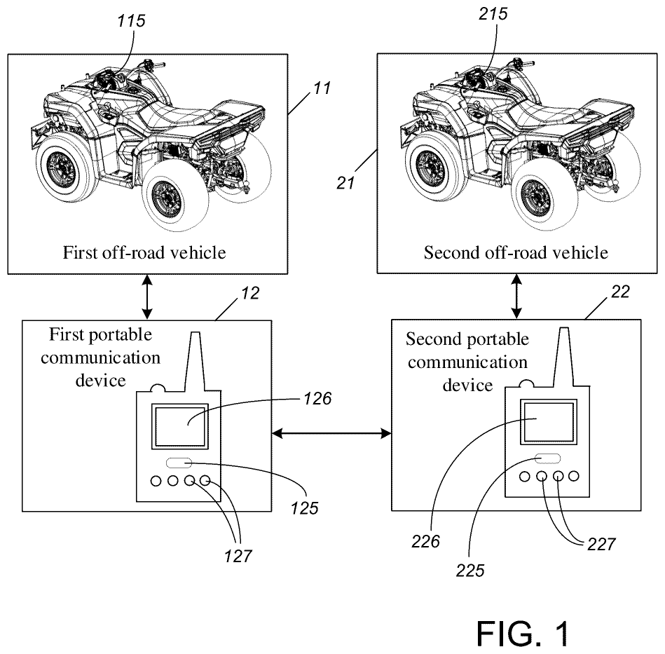

FIG. 1 is a schematic diagram of an application scenario of a communication method in accordance with a first embodiment of the present invention. The communication method is performed by a first user of a first off-road vehicle 11 (hereinafter “ORV”) having a first portable communication device 12 (hereinafter “PCD”), in communicating with a second ORV 21 and/or its user having a second PCD 22. The first and second PCDs 12, 22 are each electronic devices that can be moved and carried by hand. As shown in FIG. 1, the first PCD 12 can establish short-range unlicensed communication with the first ORV 11, and can establish long-range unlicensed communication with the second PCD 22, where the second PCD 22 establishes short-range unlicensed communication with the second ORV 21. Data exchange between the first ORV 11 and the second ORV 21 and their users is realized through this communication network.

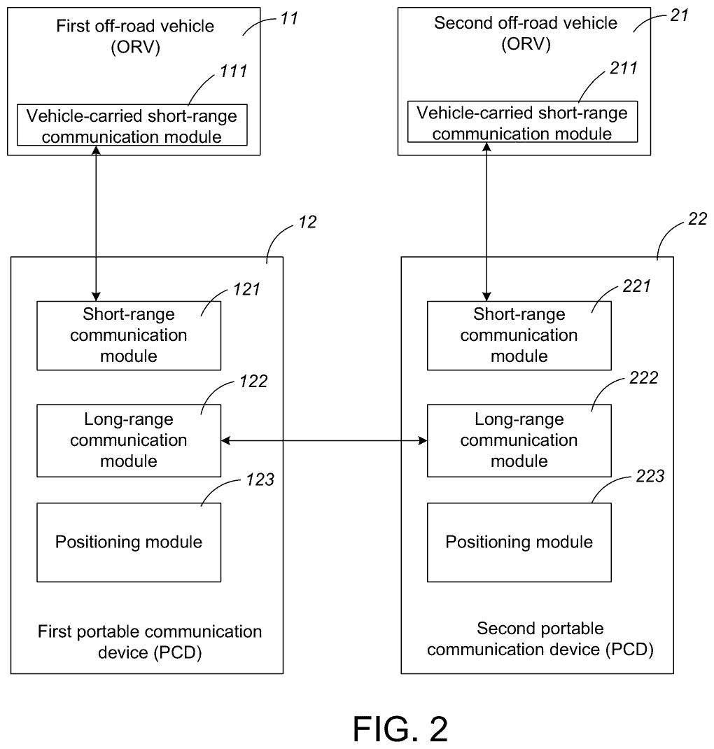

As shown in FIG. 2, the first ORV 11 includes a first vehicle-carried short-range communication module 111, and the first PCD 12 includes a first hand-carried short-range communication module 121 and a first long-range communication module 122. The second ORV 21 includes a second vehicle-carried short-range communication module 211, and the second PCD 22 includes a second hand-carried short-range communication module 221 and a second long-range communication module 222. The short-range communication modules 111, 121, 211, 221 are each a short-range (generally viewed as less than 500 m maximum transmission distance, though transmission distances up to about 1000 m may be possible in certain conditions) communication module transmitting via a) a wired connection (any type); b) Wi-Fi (radio wave bands centered at either 2.4 GHZ, 3.6 GHZ, 4.9 GHZ, 5 GHZ, 6 GHz or 60 GHz, at a power no greater than 30 dBm (1 W)); c) Bluetooth (between 2.4 and 2.5 GHz, at a power no greater than 20 dBm (100 mW); d) near field communication (NFC) (radio waves at about 13.56 MHz at no greater than 1000 mW)) e) infrared (300 gigahertz (GHz) to 400 terahertz (THz)); and f) any other short-range, low power wireless transmissions in generally unlicensed frequency bands. The preferred short-range communication modules 111, 121, 211, 221 are Bluetooth modules. The long-range communication modules 122, 222 allow low power, wide area network communications in a generally unlicensed radio frequency band and allowing transmission distances over 500 m, including a) LoRa (at a band within the 850-950 MHz range, and more preferably within the 915-918 MHz range, at a power no greater than 30 dBm (1 W), and b) any other long-range, low power wireless transmissions in generally unlicensed frequency bands. The preferred long-range communications modules 122, 222 are LoRa modules. As used in this specification, “generally unlicensed” and “low power” refers to frequency bands and power levels that can be used without obtaining a specific license by the United States Federal Communications Commission for vehicles sold in the United States, or without obtaining a specific license by a corresponding governmental agency in any foreign country for vehicles sold in such foreign country. The first and second PCDs 12, 22 also each preferably include a positioning module 123, 223 used to determine location information of the respective PCD 12, 22, such as a chip based on a global positioning system (GPS chip). As shown in FIG. 2, each PCD 12, 22 is capable of communicating with its respective vehicle-carried short-range communication module 111, 211 (and its respective ORV 11, 21) via its short-range communication module 121, 221, and the two PCDs 12, 22 are capable of communicating with each other via their long-range communication modules 122, 222. By using the two PCDs 12, 22 as intermediaries, the first ORV 11 and the second ORV 21 are capable of communicating with each other over longer distances using unlicensed communications. Moreover, because the long-range communication between the two PCDs 12, 22 does not occur over a third party cellphone network or other licensed third party network, even if the first and second ORVs 11, 21 are in a location with poor or non-existent cellphone network coverage or network outage, the connection between the first and second ORVs 11, 12 can be maintained, thereby ensuring the stability of the vehicle group. The communication between ORVs 11, 21 preferably includes “driving information”, which includes data selected from one or more of the group consisting of: vehicle velocity, engine rotational speed, fuel information, operation mode, vehicle inclination, a driving path of a ride, a driving distance for a ride, a maximum vehicle velocity during a ride, an average vehicle velocity for a ride, and driving time for a ride.

While the long-range communications between two PCDs 12, 22 in accordance with the present invention are primarily are data communications preferably including driving information, some embodiments allow the two PCDs 12, 22 to transmit voice communications with eachother. Voice communications may be transmitted, like the data communications, over LoRa. Alternatively, the PCDs 12, 22 can be designed to only transmit data communications over LoRa and to transmit voice communications instead over an FM band (i.e., within the range of 87.5 to 108 MHZ), but still at low power such as at a power output of no more than 250 microvolts per meter (u V/m) at a distance of 3 meters from the PCD 12, 22, giving an effective voice coverage radius of about 200 meters or less.

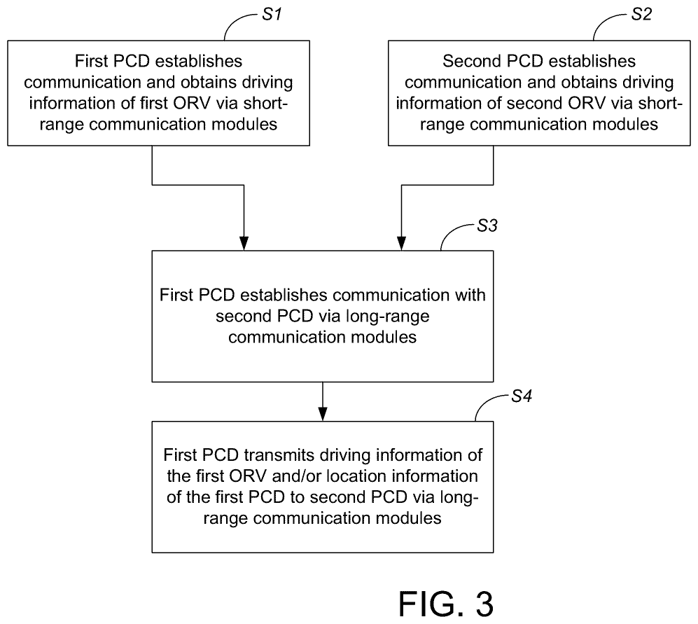

FIG. 3 shows an example of steps used in the preferred communication method. In step S1: communication is established between the first PCD 12 and the first ORV 11 based on their respective short-range communication modules 111, 121, and the first PCD 12 obtains driving information of the first ORV 11 through the communication. The establishment of communication between the first PCD 12 and the first ORV 11 may occur whenever the two short-range communication modules 111, 121 are within range of each other (or are wired to each other) and deliver sufficient signal strength (RSSI above a short-range threshold value). More preferably, the first PCD 12 carries a transmitter/responder 124 separately read by a sensor (not shown) in the first ORV 11 using existing key-fob technology (such as in 315, 434 or 868 MHz frequency bands). The first PCD 12 may include a button 125 (like a button on known key-fobs) that signals to the first PCD 12 and to the first ORV 11 to begin short-range communications (similar to unlocking a car by pressing a button on its key-fob). The first ORV 11 may alternatively include multiple antennas (not shown) reading the transmitter/responder 124 so as to enable short-range communication only whenever the first PCD 12 is determined by comparison of the various signals to be inside the ORV 11 (similar to cars with keyless entry, locking and start systems, that won't start with the key-fob outside the car and that disable external locking if the key-fob is left within the car). In another embodiment of the present invention, the ORV 11 includes a placement area (not shown, such as a console or dashboard surface) for placing the first PCD 12. When the first PCD 12 is placed in the placement area of the first ORV 11, communication between the two short-range communication modules 111, 121 is attempted. Use of such key-fob or separate sensing technology avoids constantly attempting to establish communication between the first-ORV 11 and the first PCD 12 while out-of-range, thereby avoiding useless power consumption. By limiting communication between the first PCD 12 and the first ORV 11 to times when the first PCD 12 is separately sensed/determined to be within the first ORV 11, unauthorized portable communication devices are prevented from maliciously establishing communication with the ORV 11, ensuring communication security.

In step S2: communication is established between the second PCD 22 and the second ORV 21 based on their respective short-range communication modules 211, 221, and the second PCD 22 obtains driving information of the second ORV 21 through the communication. The establishment of communication between the second PCD 22 and the second ORV 21 mirrors the establishment of communication between the first PCD 12 and the first ORV 11 described above.

In the preferred embodiment of the present invention, there is a mapping/handshaking relationship between each PCD 12, 22 and its respective ORV 11, 21. That is, there is an initial set-up procedure including the transfer of identifying information, after which the first ORV 11 will only transmit data to the first PCD 12 (and not to other short-range radios that haven't gone through the set-up procedure), and the first short-range communication module 121 of the first PCD 12 will only communicate with the corresponding short-range communication module 111 of the first ORV 11 (and not with other off-road vehicles). Similarly, after its initial set-up procedure, the second PCD 22 and the second ORV 21 will only perform short-range communication with each other.

In step S3: the first PCD 12 establishes communication between the first PCD 12 and the second PCD 22 via the respective long-range communication modules 112, 212. The establishment of communication between the first PCD 12 and the second PCD 22 preferably occurs whenever a) the first PCD 12 is in communication with the first ORV 11; b) the second PCD 22 is in communication with the second ORV 21; and c) the two long-range communication modules 112, 212 are within range of each other and deliver sufficient signal strength (RSSI above a long-range threshold value). In some embodiments, a fourth requirement is added, that the first PCD 12 and the second PCD 22 will only begin communicating with each other when the two PCDs 12, 22 are within a pre-set vicinity of each other as verified based on comparing data between the positioning modules 123, 223 of the two PCDs 12, 22. The pre-set vicinity can be significantly different than the range of long-range communications, for instance, two PCDs 12, 22 may begin communicating only when within 50 m of each other, even if the LoRa modules 122, 222 can communicate up to 16 km during the course of a ride.

In some embodiments of the present application, the set-up/mapping relationship between a given portable communication device and its corresponding off-road vehicle requires authentication through an on-line server, possibly requiring a terminal device such as a mobile phone or personal computer to be in communication with either the portable communication device or the off-road vehicle. Similarly, in some embodiments of the present application, communication between the first PCD 12 and the second PCD 22 requires initial authentication through an on-line server to provide a mapping relationship. The server-verified mapping instructions for connecting two portable communication devices may include vehicle identifying information. By requiring initial authentication of the mapping relationships between each portable communication device and its off-road vehicle and between two portable communication devices, unauthorized communications can be prevented, ensuring communication security.

In step S4: the first PCD 12 sends location information of its positioning module 123 and/or driving information of its first ORV 11 to the second PCD 22 via the long-range communication modules 122, 222. In some embodiments, the data is sent in real time to achieve data synchronization between ORVs in an off-road vehicle group. In other embodiments, data is sent at pre-determined time intervals during the running of the first ORV 11. In either or both cases, driving information of the first ORV 11 and the location information of the first PCD 12 can also be sent to the second PCD 22 when the running of the first ORV 11 is stopped, so that the user corresponding to the second PCD 22 can evaluate driving path and status of the first ORV 11 as a whole trip.

While FIG. 3 shows the method of communication to be in one direction, i.e., from the “first” ORV/PCD/user to the “second” PCD/ORV/user, the preferred system is bi-directional. Communications can occur in either direction or in both directions according to the circumstances, and either at short intervals (nearly continuously) or with extended pauses between communications.

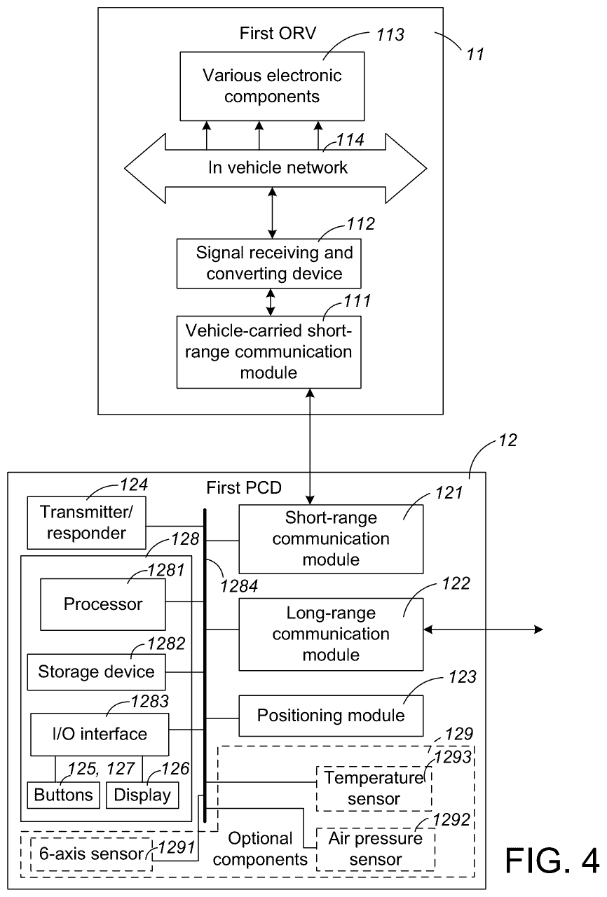

In many embodiments of the present invention, as shown in FIG. 4, the first ORV 11 includes a signal receiving and converting device 112. The signal receiving and converting device 112 of the first ORV 11 is capable of communicating with various electronic components 113 in the first ORV 11 based on an in-vehicle network 114. The in-vehicle network 114 may be a controller area network bus (CAN-Bus), in which case the signal receiving and converting device 112 can convert CAN-Bus driving information data into a format such as one or more Bluetooth data packets to be transmitted on via the first vehicle-carried short-range communication module 111.

In the preferred embodiments and as shown in FIG. 1, each PCD 12, 22 includes a respective display screen 126, 226. Using data from the first positioning module 123, location information of the first PCD 12 is preferably displayed on the display screen 126 of the first PCD 12, such as using a dot shown on a map on the display screen 126. After acquiring location information of the second PCD 22 through its first long-range communication module 122, the first PCD 12 also shows location information of the second PCD 22 on its display screen 126. Correspondingly, the display screen 226 of the second PCD 22 preferably similarly shows location information of both the first and second PCDs 12, 22.

After the first PCD 12 obtains driving information of the first ORV 11 through its first short-range communication module 121, the first PCD 12 preferably also shows the driving information of the first ORV 11 on its display screen 126. By displaying driving information of the first ORV 11 on the display screen 126 of the first PCD 12, it is convenient for the user corresponding to the first ORV 11 to understand the operation status of the first ORV 11 and control the first ORV 11. In preferred embodiments, when the first PCD 12 receives driving information of the second ORV 21 through its first long-range communication module 122, the first PCD 12 also shows the driving information of the second ORV 21 on its display screen 126. Correspondingly, the display screen 226 of the second PCD 22 preferably similarly shows driving information of both the first and second ORVs 11, 21.

The preferred ORVs 11, 21 each also or alternatively have their own ORV display screens 115, 215. The first PCD 12 preferably provides location information of both the first PCD 12 and the second PCD 22 via transmission from its short-range communication module 121 to the short-range communication module 111 of the first ORV 11, which is then preferably displayed on the ORV display screen 115 of the first ORV 11. The second PCD 22 preferably provides location information of both the first PCD 12 and the second PCD 12 via transmission from its short-range communication module 221 to the short-range communication module 211 of the second ORV 21, which is then preferably displayed on the ORV display screen 215 of the second ORV 21. Similarly, the ORV display screens 115, 215 of both vehicles 11, 21 also preferably show vehicle information of both vehicles 11, 21, with the vehicle information of the other vehicle having first been transmitted through short-range, then long-range, then short-range transmissions. In some embodiments, showing location and vehicle information of both vehicles 11, 21 on the ORV display screens 115, 215 may be redundant of what is shown on the display screens 126, 226 of the two PCDs 12, 22. In other embodiments where the first and second PCDs 12, 22 lack display screens of their own, showing location and vehicle information of both vehicles 11, 21 on the ORV display screens 115, 215 is particularly beneficial.

In preferred embodiments, the first PCD 12 and the second PCD 22 can maintain communication via their long-range communication modules 122, 222 even after or when either or both PCDs 12, 22 are separated from their respective ORV 11, 21. Location information of the PCDs 12, 22 can be displayed on one or both display screens 126, 226 even after or when either or both PCDs 12, 22 are separated from their respective ORV 11, 21. For example, a first user might take the first PCD 12 with them when leaving the first ORV 11 by walking, riding a bicycle, etc., while still using the display screen 126 of the first PCD 12 to follow the travel of the second PCD 22, thereby making it easier for both users to meet up with each other at a location away from the first ORV 11. Vehicle information of the second ORV 21 can be displayed on the display screen 126 of the first PCD 12 even after or when the first PCD 12 is separated from its first ORV 11, and vice versa for the second PCD 22.

Each PCD 12, 22 includes other components 128 to enable it to properly function, and also may contain other optional components 129. For instance, as further shown in FIG. 4, the first PCD 12 preferably includes a processor 1281, a storage device 1282 and an input/output (I/O) interface 1283. The processor 1281 is coupled to the communication modules 121, 122, the positioning module 123, the transmitter/responder 124, the storage device 1282, and the I/O interface 1283 through a bus 1284. The storage device 1282 stores computer-readable instructions and/or data. The processor 1281 implements various functions by running or executing the computer-readable instructions stored in the storage device 1282 and invoking the data stored in the storage device 1282. For instance, the preferred storage device 1282 mainly includes a program storage area and a data storage area, where the program storage area can store an operating system, and installed application(s) required for at least one function (such as a sound playback function, an image playback function, etc.). The storage device 1282 can include internal and/or external non-volatile and/or volatile memories, such as: read-only memory (ROM), random access memory (RAM), a hard disk, a smart media card (SMC), a secure digital (SD) card, a flash card, a trans-flash (TF) card, a memory stick, a flash memory device, or other storage devices. The processor 1281 may be a central processing unit (CPU), or other general-purpose processors, digital signal processors (DSP), application-specific integrated circuits (ASIC), field-programmable gate arrays (FPGA) or other programmable logic devices, discrete gate or transistor logic devices, discrete hardware components, etc. The I/O interface 1283 is used to connect various input and output devices, such as the buttons 125, 127, the display screen 126, etc., so that the user can enter information or visualize information. The bus 1284 is used to provide a communication channel for the various components 121-129.

Other optional components 129 (shown in dashed lines) may include a built-in 6-axis sensor 1291, an air pressure sensor 1292, and a temperature sensor 1293 used to better obtain “target information”. As used herein, target information may include one or more of vehicle speed information, acceleration information, altitude information and temperature information. If desired, target information may also be shown on either or both display screens 126, 226.

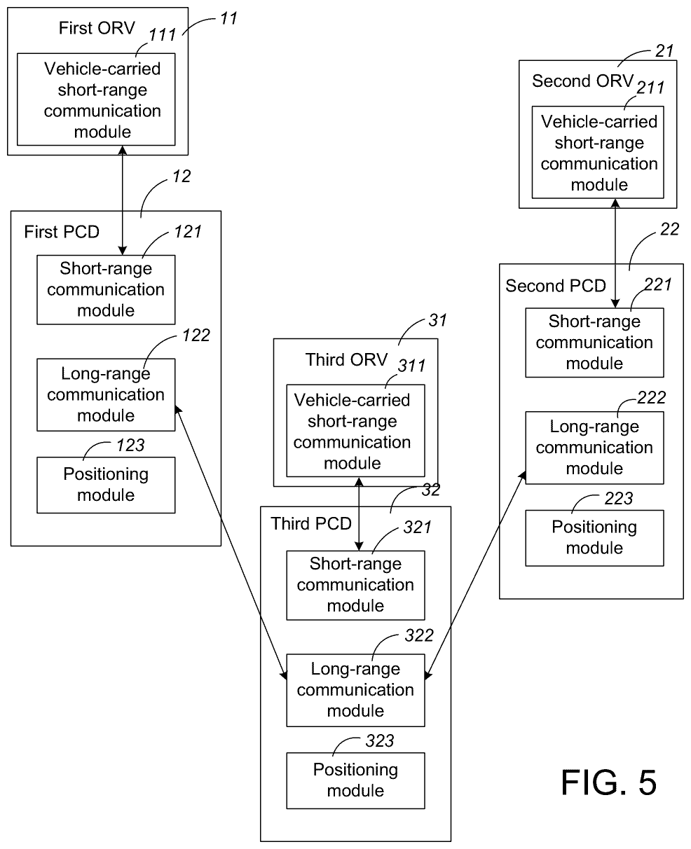

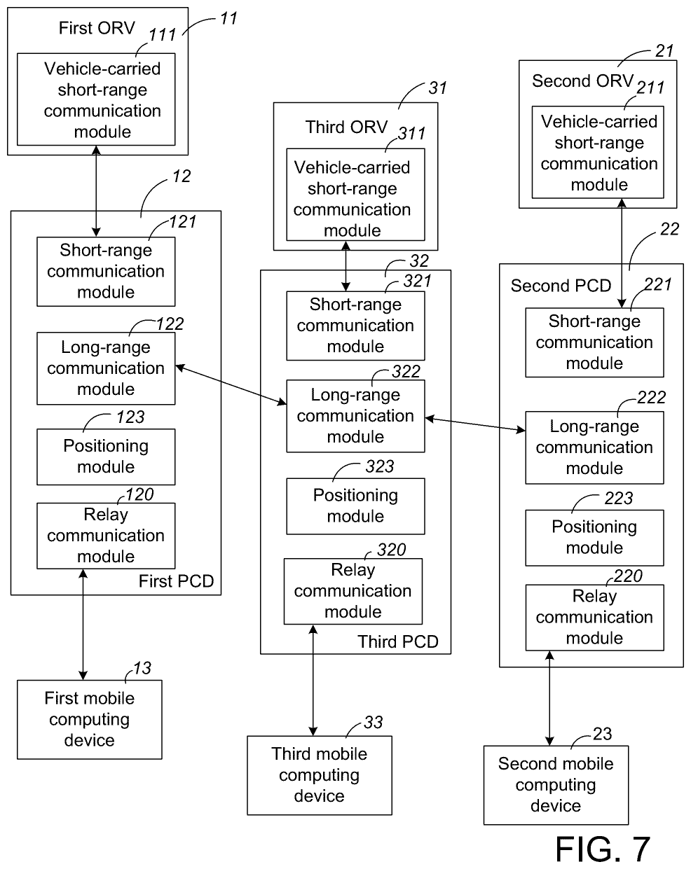

Thus far, the description of the off-road vehicle group includes only two off-road vehicles (the first ORV 11 and the second ORV 12) and only two portable communication devices (the first PCD 12 and the second PCD 22). The present invention allows for a reasonable number of subsequent off-road vehicles with assigned portable communication devices to be added to the off-road vehicle group. For example, FIG. 5 shows a third ORV 31, having a third PCD 32, which has joined the off-road vehicle group with the first ORV 11 and the second ORV 21. The third PCD 32 similarly has a third short-range communication module 321, a third long-range communication module 322, and a third positioning module 323, all of which function as described above for the first and second PCDs 12, 22. The location information of all three PCDs 12, 22, 32 can preferably be shown on the display screen 126 of the first PCD 12, and/or on the display screen 226 of the second PCD 22, and/or on the display screen 326 (shown in FIG. 7) of the third PCD 32, and so on as additional ORVs and PCDs join the group, all communicated via the long-range communication modules 122, 222, 322. The driving information of all three ORVs 11, 21, 31 (communicated firstly via the ORV's respectively paired short-range communication modules 111/121, 211/221 or 311/321 and secondly via the long-range communication modules 122, 222, 322) can also preferably be shown on the display screen 126 of the first PCD 12, and/or on the display screen 226 of the second PCD 22, and/or on the display screen 326 (shown in FIG. 7) of the third PCD 32, and so on as additional ORVs and PCDs join the group.

Further ORVs and their respective PCDs in the group can be daisy-chained together. Even if the second ORV 21 and its PCD 22 travel beyond the range of the long-range communication modules 122, 222, location information and/or driving information may still be able to be shared so long as both the first ORV/PCD pair 11/12 and the second ORV/PCD pair 21/22 remain within range of the third ORV 31 and the long-range communication module 322 of its paired third PCD 32. For instance, if the range of long-range communication is 16 km, the second PCD 22 may still display the vehicle information of the first ORV 11 and the location information of the first PCD 12 while it is more than 16 km but less than 32 km away from the first PCD 12, provided the first PCD 12 and the second PCD 22 are each still within 16 km of the third PCD 32. Three or more portable communication devices can accordingly be used to form an extended network of ORV/PCD pairs.

Some embodiments of the present application further allow use of transmitted notification instructions. As used herein, notification instructions cause either a visual, sound or haptic alert to be displayed to one or more different users in the group. For instance, the notification information may be selected from a group consisting of an incoming call, a request for a return call, an alarm, etc. By pressing a certain button 127 on the first PCD 12 once or in a sequence with itself or other buttons, the user of the first PCD 12 can long-range send a notification instruction to the second ORV/PCD pair 21/22, to the third ORV/PCD pair 31/32, or to all ORV/PCD pairs within the group. For example, when the notification instruction is an alarm, the second PCD 22 (if so equipped) can perform audible prompts such as a horn prompt and a buzzer prompt, or more preferably can send the notification instruction via the pairing of short-range communication modules 211, 221 to control the second off-road vehicle 21 and then through a signal receiving and converting device (not shown) and in-vehicle network (not shown) of the second off-road vehicle 21 to control various electronic components (not shown) of the second off-road vehicle 21 perform a horn prompt, a buzzer prompt, a vehicle instrument prompt, and/or other prompts.

Some embodiments of the present application further allow use of transmitted control instructions, executed similarly to the notification instructions described above. As used herein, control instructions modify performance of a different off-road vehicle in the group. For example, a control instruction may be selected from the group consisting of an emergency stop instruction and a speed limit instruction. The emergency stop instruction is used to control a selected vehicle(s) to stop its (their) engine(s). The speed limit instruction is used to control a selected vehicle(s) to reduce/maintain vehicle speed below a selected or pre-determined speed threshold. Notification instructions and control instructions may be sent to all ORVs in a group, or to only one or several specific ORVs in a group.

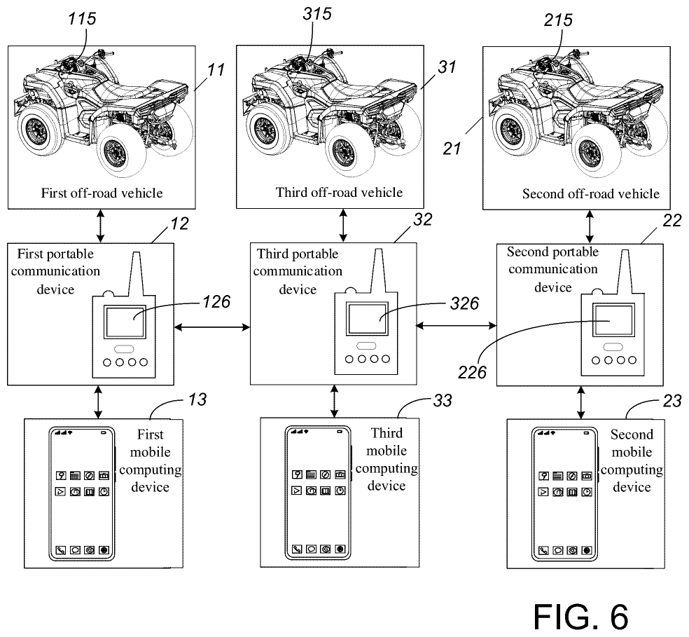

FIGS. 6 and 7 show another set of embodiments of the present invention. Each of the PCDs 12, 22, 32 include a respective relay communication module 120, 220, 320 used for communicating with one or more corresponding mobile computing devices 13, 23, 33. Each mobile computing device 13, 23, 33 can be a device with more sophisticated input, output and display capabilities than the corresponding PCD 12, 22, 32, such as a smartphone, a tablet, or a personal computer. The mobile computing device 13, 23, 33 will typically be connected into a publicly available network, such as a cellphone network and/or with access to the internet. In some embodiments, the relay communication module 120, 220, 320 can be omitted in favor of allowing the PCD 12, 22, 32 communicate with its respective mobile computing device 13, 23, 33 using the short-range communication module 121, 221, 321. More preferably, each relay communication module 120, 220, 320 operates differently than either the short-range communication module 121, 221, 321 or the long-range communication module 122, 222, 322. For instance, the preferred relay communication modules 120, 220, 320 communicate over WiFi. The use of such mobile computing devices 13, 23, 33 is particularly helpful to simplify and/or reduce the cost of the PCDs 12, 22, 32, such as by simplifying or eliminating buttons 125, 127 and display screens 126, 226, 336. Each mobile computing device 13, 23, 33 can preferably display the vehicle information of all ORVs in the group and the location information of all PCDs in the group, with both types of information having been transmitted through the respective relay communication module 120, 220, 320. Each mobile computing device 13, 23, 33 can also preferably provide notification instructions and/or control instructions to the same degree as its respective PCD 12, 22, 32. For instance, a user may enter a control instruction to limit the speed of the second ORV to below 25 kph into the first mobile computing device 13, which speed control instruction is first transmitted to the relay communication module 120 of the first PCD 12, and then via long-range communication modules 122, 322 to the third PCD 32, and then via long-range communication modules 322, 222 to the second PCD 22, and then via short-range communications modules 221, 211 to the second ORV 21, causing the second ORV 21 to maintain its speed below the 25 kph limit regardless of the throttle control of the driver of the second ORV 21.

The use of mobile computing devices 13, 23, 33 can also enable further features of networking of ORVs. For example, the use of mobile computing devices 13, 23, 33 can establish network rules of notification instructions and control instructions. A central computer can establish permissions for which PCDs can provide which notification instructions and which control instructions to which ORVs at which time. For example, the second PCD 22 may only be able to send an instruction over its long-range communication module 222 to shut down the first ORV 11 during a particular time window or while the first PCD 12 is in a particular location, with the particular time window and the particular location being definable over the internet. Communications between mobile computing devices 13, 23, 33 may be used to decide which ORVs are included or excluded from the group at which times. As groups get larger and more geographically diverse, the mobile computing devices 13, 23, 33 may be used to establish or maintain portions (branches) of groups which are outside the possible coverage of the collection of long-range communication modules 122, 222, 322. A single group can be established, with vehicles in two ORV parks, with the two ORV parks being located hundreds or thousands of kilometers apart, all with a central control and notification possibilities. Communications with each vehicle 11, 21, 31 are accomplished via respective short-range communication module pairs 111/121, 211/221, 311/321; communications between PCDs 12, 22, 32 within any group branch are accomplished via long-range communication modules 122, 222, 322; whereas communications between geographically diverse group branches are accomplished through mobile computing devices 13, 23, 33 either over the internet or over a cellphone network. Mobile computing devices 13, 23, 33 can also be used to target additional possible ORVs to be included in a group, to thereby enlarge the collective range of long-range daisy-chained transmissions.

In preferred embodiments, joining a group requires the acceptance of users of each ORV 11, 21, 31 in the group and/or its user. In preferred embodiments, leaving a group is accomplished solely by control of the user of that vehicle. For instance, the third ORV 31 and third PCD 32 can only join the group with the permission of both the user of the first ORV/first PCD 11/12 and the user of the second ORV/second PCD 21/22. However, the third ORV/third PCD 31/32 can disconnect from the group at any time without permission of either the user of the first ORV/first PCD 11/12 or the user of the second ORV/second PCD 21/22, such as by either pressing a disconnection button or power off button of the third PCD 32. In other embodiments, a central server (not shown) controls which ORV/PCD pairs are in which group(s). In some embodiments, leaving a group may invoke a separate control instruction, such as limiting vehicle speed below 25 kph, so a user cannot avoid a control instruction merely by leaving the group.

The above-mentioned embodiments are only used to illustrate the present invention, rather than to serve as limitations, which are solely limited by the appended claims. Although such embodiments are described in detail, those skilled in the art understand that they can still modify the disclosed technical solutions within the protection scope of the present application, or replace some of the technical features therein by equivalents; and these modifications or replacements do not deviate from the spirit and scope of the present invention, and should all be included.

1. A communication method for an off-road vehicle group, the off-road vehicle group comprising at least a first off-road vehicle and a second off-road vehicle; the method comprising:
providing a first portable communication device, the first portable communication device comprising a first short-range communication module, a first long-range communication module, and a first positioning module, the first short-range communication module being capable of establishing unlicensed communication with the first off-road vehicle and acquiring driving information of the first off-road vehicle;
providing a second portable communication device, the second portable communication device comprising a second short-range communication module and a second long-range communication module, the second short-range communication module being capable of establishing communication with the second off-road vehicle and acquiring driving information of the second off-road vehicle; and
transmitting driving information of the first off-road vehicle and positioning information of the first portable communication device from the first long-range communication module to the second long-range communication module via an unlicensed communication over a communication distance greater than a range of the first and second short-range communication modules.

2. The communication method of claim 1, wherein the first and second short-range communication modules allow communications via a group consisting of:
a) a wired connection;
b) Wi-Fi;
c) Bluetooth;
d) near field communication (NFC); and
e) infrared.

3. The communication method of claim 1, wherein the first long-range communication module transmits driving information of the first off-road vehicle and positioning information of the first portable communication device to the second long-range communication module via LoRa.

4. The communication method of claim 1, wherein the first portable communication device only obtains driving information of the first off-road vehicle while the first portable communication device is determined to be within the first off-road vehicle.

5. The communication method of 1, wherein the first portable communication device further comprises a first relay communication module which is different from the first short-range communication module and different from the first long-range communication module, the method further comprising:
establishing communication between the first relay communication module of the first portable communication device and a first mobile computing device;
sending location information of the first portable communication device and driving information of the first off-road vehicle from the first relay communication module to the first mobile computing device; and
displaying location information of the first portable communication device and driving information of the first off-road vehicle on the first mobile computing device.

6. The communication method of claim 5, further comprising:
sending an instruction from the first mobile computing device to the first portable communication device via the first relay communication module;
thereafter sending the instruction from the first long-range communication module of the first portable communication device to the second long-range communication module of the second portable communication device;
thereafter transmitting from the second portable communication device to the second off-road vehicle to cause the second off-road vehicle to act in accordance with the instruction.

7. The communication method of 1, wherein the first portable communication device further comprises a first relay communication module which is different from the first short-range communication module and different from the first long-range communication module, the method further comprising:
establishing communication between the first relay communication module of the first portable communication device and a first mobile computing device;
sending an instruction from the first mobile computing device to the first portable communication device via the first relay communication module;
thereafter sending the instruction from the first short-range communication module of the first portable communication device to the first off-road vehicle to cause the first off-road vehicle to act in accordance with the instruction.

8. The communication method of claim 1, further comprising:
sending a control instruction from the first long-range communication module of the first portable communication device to the second long-range communication module of the second portable communication device;
thereafter transmitting from the second portable communication device to the second off-road vehicle to cause the second off-road vehicle to modify its performance.

9. The communication method of claim 1, further comprising:
sending a notification instruction from the first long-range communication module of the first portable communication device to the second long-range communication module of the second portable communication device;
thereafter transmitting from the second portable communication device to the second off-road vehicle to cause the second off-road vehicle to perform a horn prompt, a buzzer prompt, or a vehicle instrument prompt.

10. The communication method of claim 1, wherein the second portable communication device comprises a display screen, the method further comprising: displaying the location information of the first portable communication device and the driving information of the first off-road vehicle on the display screen of the second portable communication device.

11. The communication method of claim 1, wherein the first portable communication device comprises a display screen, the method further comprising: displaying the location information of the first portable communication device and the driving information of the first off-road vehicle on the display screen of the first portably communication device.

12. The communication method of claim 1, further comprising:
transmitting driving information of the first off-road vehicle from the second short-range communication module to the second off-road vehicle.

13. The communication method of claim 12, further comprising:
displaying driving information of the first off-road vehicle on a display of the second off-road vehicle.

14. The communication method of claim 1, further comprising:
transmitting positioning information of the first portable communication device from the second short-range communication module to the second off-road vehicle.

15. The communication method of claim 14, further comprising:
displaying positioning information of the first portable communication device on a display of the second off-road vehicle.

16. The communication method of claim 1, further comprising:
providing a third portable communication device, the third portable communication device comprising a third short-range communication module and a third long-range communication module;
wherein the act of transmitting driving information of the first off-road vehicle and positioning information of the first portable communication device from the first long-range communication module to the second long-range communication module comprises:
transmitting driving information of the first off-road vehicle and positioning information of the first portable communication device from the first long-range communication module to the third long-range communication module via an unlicensed communication over a communication distance greater than a range of the first, second and third short-range communication modules; and
transmitting driving information of the first off-road vehicle and positioning information of the first portable communication device from the third long-range communication module to the second long-range communication module via an unlicensed communication over a communication distance greater than a range of the first, second and third short-range communication modules.

17. A communication method for an off-road vehicle group, the off-road vehicle group comprising at least a first off-road vehicle and a second off-road vehicle; the method comprising:
providing a first portable communication device, the first portable communication device comprising a first short-range communication module and a first long-range communication module, the first short-range communication module being capable of establishing unlicensed communication with the first off-road vehicle and acquiring driving information of the first off-road vehicle only when the first portable communication device is determined to be within the first off-road vehicle;
providing a second portable communication device, the second portable communication device comprising a second short-range communication module and a second long-range communication module, the second short-range communication module being capable of establishing communication with the second off-road vehicle and acquiring driving information of the second off-road vehicle; and
transmitting driving information of the first off-road vehicle from the first long-range communication module to the second long-range communication module via an unlicensed communication over a communication distance greater than a range of the first and second short-range communication modules.

18. The communication method of claim 17, wherein the first and second short-range communication modules allow communications via a group consisting of:
a) a wired connection;
b) Wi-Fi;
c) Bluetooth;
d) near field communication (NFC); and
e) infrared.

19. The communication method of claim 18, wherein the first long-range communication module transmits driving information of the first off-road vehicle to the second long-range communication module via LoRa.

20. A communication method for an off-road vehicle group, the off-road vehicle group comprising at least a first off-road vehicle, a second off-road vehicle and a third off-road; the method comprising:
providing a first portable communication device, the first portable communication device comprising a first short-range communication module, a first long-range communication module, and a first positioning module, the first short-range communication module being capable of establishing unlicensed communication with the first off-road vehicle and acquiring driving information of the first off-road vehicle;
providing a second portable communication device, the second portable communication device comprising a second short-range communication module, a second long-range communication module, and a second positioning module, the second short-range communication module being capable of establishing communication with the second off-road vehicle and acquiring driving information of the second off-road vehicle;
providing a third portable communication device, the third portable communication device comprising a third short-range communication module, a third long-range communication module, and a third positioning module, the third short-range communication module being capable of establishing communication with the third off-road vehicle and acquiring driving information of the third off-road vehicle, and
transmitting positioning information of the first portable communication device from the first long-range communication module to the second long-range communication module via an unlicensed communication over a communication distance greater than a range of the first and second short-range communication modules, wherein the act of transmitting positioning information of the first portable communication device from the first long-range communication module to the second long-range communication module comprises:
transmitting positioning information of the first portable communication device from the first long-range communication module to the third long-range communication module via an unlicensed communication over a communication distance greater than a range of the first, second and third short-range communication modules; and
transmitting positioning information of the first portable communication device from the third long-range communication module to the second long-range communication module via an unlicensed communication over a communication distance greater than a range of the first, second and third short-range communication modules.
